(19) United States
(12) Patent Application Publication
(10) Pub. No.: US 2009/0309763 A1
(43) Pub. Date: Dec. 17, 2009

(54) Emergency lighting for a helicopter

(76) Inventor: Hans-Christian Lierow, Hamburg (DE)

Correspondence Address: ALIX YALE & RISTAS LLP, 750 MAIN STREET, SUITE 1400, HARTFORD, CT, 06103, US

(21) Appl. No.: 12/214,086

(22) Filed: Jun. 17, 2008

(51) Int. Cl. B64D 47/06; B64D 47/02

(52) U.S. Cl. 340/981; 362/470

(57) ABSTRACT

An aircraft, in particular a helicopter, has light elements which are in the form of strips and are fitted to the edge of at least a number of windows. The light elements are provided with photoluminescent material.

### BACKGROUND

The invention relates to an aircraft, in particular a helicopter, having emergency light elements which are fitted to the edge of at least a number of windows.

In many aircraft, particularly in helicopters, it is necessary in the event of an emergency to leave the aircraft through a window. By way of example, helicopters have sliding doors which may jam in the event of an accident so that they can no longer be opened. The helicopter crew and passengers must then leave the helicopter through a window which is either knocked out or else is provided with a device which makes it possible to remove the pane easily.

In order to allow the people in the helicopter to identify the windows through which they can leave the helicopter, even when it is dark and in the presence of smoke, or in order to allow helpers to identify these windows from the outside, even in dirty water, it is known for light elements which are in the form of strips to be provided at the edge of at least a number of windows and to be linked to an emergency power supply which is switched on or is connected to the light elements in the event of an accident. The light elements for this purpose have incandescent lamps or LEDs, for example.

One disadvantage in this case is that the emergency power supply can fail. The emergency power supply that is provided for this purpose, and the incandescent lamps or LEDs, are also relatively expensive.

An object is to provide an aircraft of the type mentioned initially, in which the emergency lighting can be produced at a lower cost and operates more reliably.

### SUMMARY

A helicopter has light elements which are in the form of strips and are fitted to the edge of at least a number of windows. The light elements are provided with photoluminescent material.

In one embodiment, the light elements have different colors. In other embodiments, the light elements have different brightnesses. The windows may be completely surrounded by light elements. In another embodiment, a number of windows are only partially surrounded by light elements. Various light element configurations may be provided to identify various windows.

### BRIEF DESCRIPTION OF THE DRAWINGS

FIG. 1 is a side elevational view of a window panel for a helicopter incorporating lighting strips;

FIG. 2 is a side elevational view of a window panel for a helicopter incorporating lighting strips in a second configuration;

FIG. 3 is a fragmentary exterior view of a helicopter window incorporating an emergency lighting strip system comprising lighting strips;

FIGS. 4A, 4B and 4C are helicopter windows which incorporate various lighting strip configurations;

FIG. 5 is a helicopter window incorporating another lighting strip configuration; and

FIG. 6 is a representative view of an emergency lighting strip configuration illustrating interior lighting characteristics during a darkened condition in relation to a helicopter window.

### DETAILED DESCRIPTION

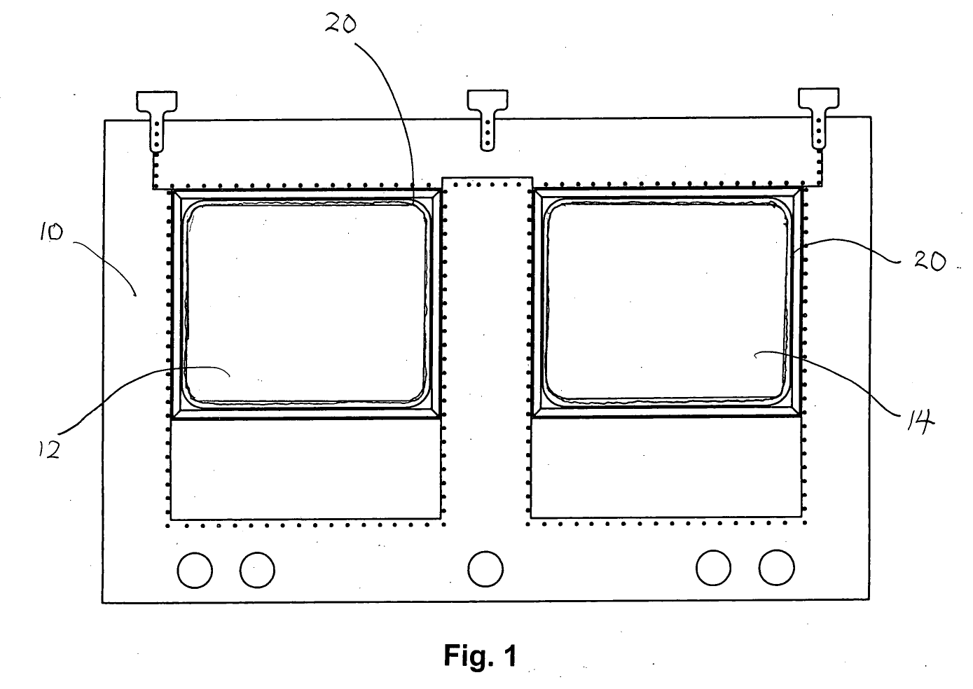

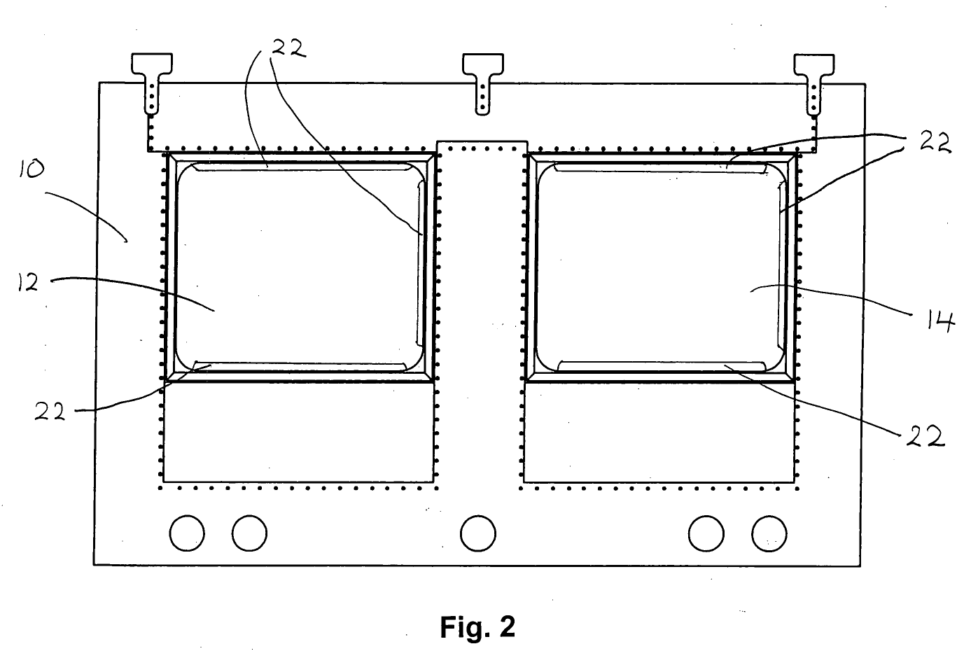

With reference to the drawings wherein like numerals represent like parts throughout the figures, an emergency lighting system which has particular applicability in connection with helicopters is illustrated in FIGS. 1 and 2 in relation to an interior panel 10 having a pair of windows 12 and 14 for descriptive purposes. Numerous additional windows are ordinarily employed. Light elements in the form of strips 20 and 22 are fitted at the edge of the windows. The light strips 20 and 22 are composed of photoluminescent material. Light strips 20 (FIG. 1) completely surround the windows 12 and 14. For some application, light strips 22 (FIG. 2) only partly surround the windows 12 and 14.

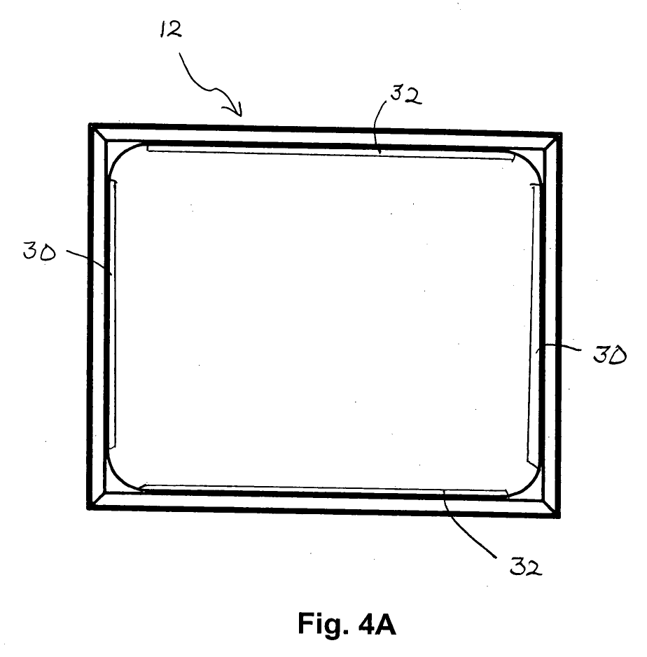

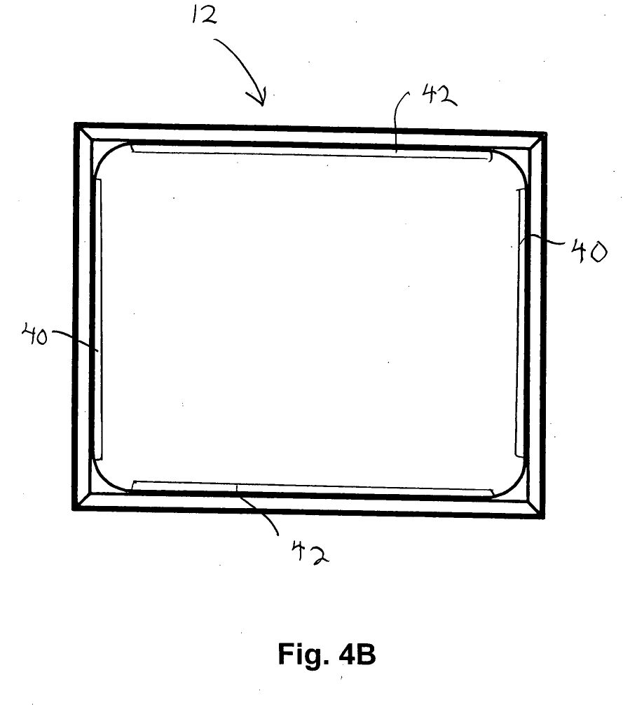

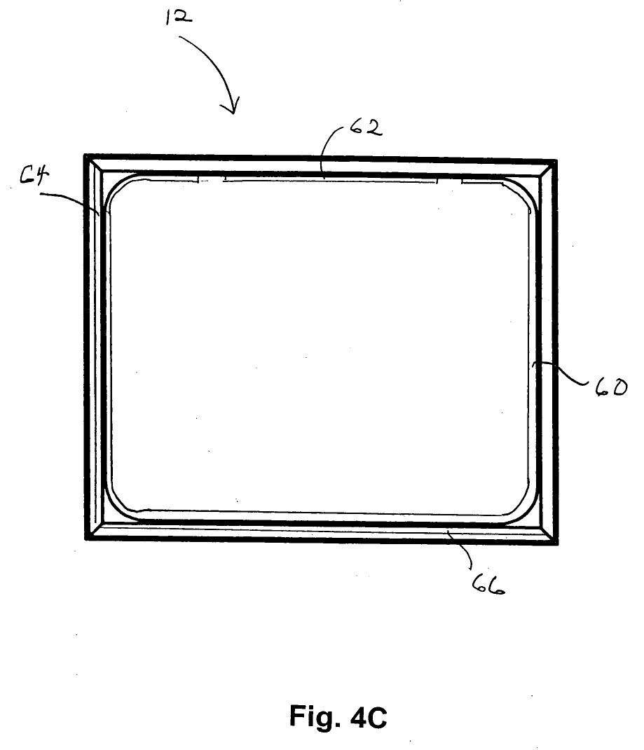

With reference to FIG. 4A, illustrated photoluminescent light elements 30 and 32 have different colors. In FIG. 4B, the light elements 40 and 42 have different brightnesses.

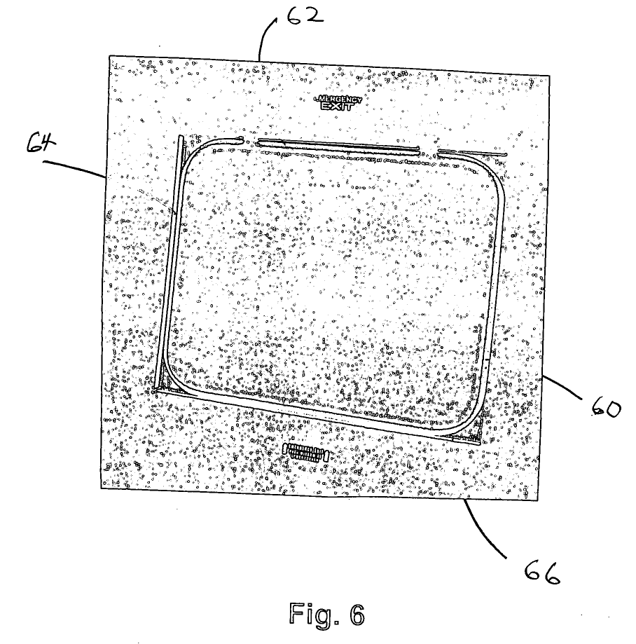

In FIG. 4C, a composite light scheme composed of strips 60, 62, 64, 66 is illustrated. A representative light pattern for FIG. 4C during a darkened condition is illustrated in FIG. 6.

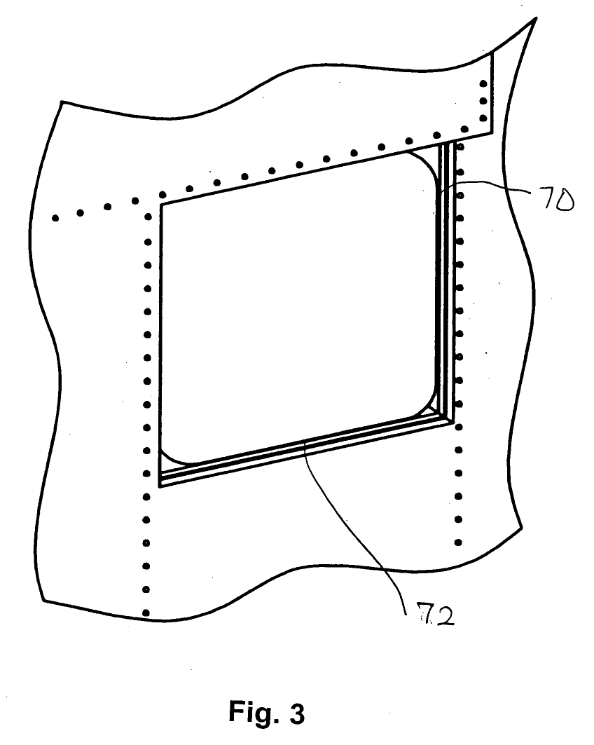

In FIG. 3, the window is illustrated with photoluminescent light strips 70 and 72 as seen from the exterior of the helicopter.

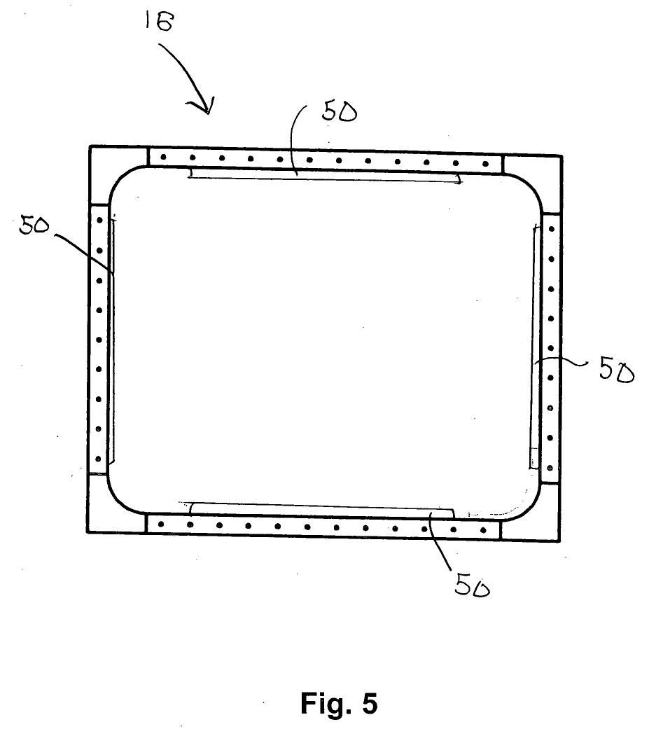

In FIG. 5, the window 16 is only partly surrounded by photoluminescent light elements 50.

The light elements are provided with photoluminescent material. The photoluminescent light elements do not require a separate energy source. They are caused to illuminate by daylight, cabin lighting, etc., and also continue to fluoresce for some time after the lighting has ended.

This therefore avoids the need for incandescent lamps or LEDs, and an emergency power supply to feed them. The system is therefore simpler and more reliable. It is admittedly known for photoluminescent strips to be provided in aircraft, by means of which the route to the exits is indicated to the crew and passengers in the event of an accident (WO 2004/076280 A1). The use of fluorescent strips such as these has admittedly been found to be advantageous and expedient for aircraft. However, there are particular problems, which do not occur in airplanes, when using such fluorescent strips in other aircraft, in particular helicopters.

On the one hand, the light strips must light up very brightly in order that they can still be seen even in difficult conditions. For example, this is the situation when smoke is being produced. This problem is less critical in the case of airplanes since the light strips are arranged on the floor, while the smoke rises upwards, so that the light strips can still be seen even when smoke is being produced. This is not the case in helicopters, whose internal area is relatively small. The light strips must also be identifiable from the outside in difficult conditions, for example when the helicopter is in dirty water, in order to allow rescuers to identify the windows. Once again, this problem does not occur with airplanes, since, in that case, rescuers at the most have to open the doors which, however, cannot be provided with light strips such as these, since the doors are opaque.

While incandescent lamps or LEDs can have sufficient brightness to allow the windows to be seen even in difficult conditions, the light intensity of photoluminescent elements is restricted. The primary advantage is the fact that it has been identified that adequate brightness can be achieved by suitable choice of the thickness of the illuminating layer of the light elements and by an appropriately high pigment concentration.

The photoluminescent materials are preferably composed of photoluminescent pigments which are embedded into a plastics matrix. The plastics matrix for example can be composed of thermoplastic materials (e.g. polycarbonate, polypropylene, polythene, etc.) which can be processed by injection molding or extrusion processes, or can be composed of thermosetting plastics (e.g. epoxy resin, polyester resin, acrylics varnish, polyurethane varnish, etc.) in order to be processed by molding or by coating of carrier materials.

The afterglow properties can be influenced with respect to the afterglow brightness, afterglow duration and afterglow color by choosing the suitable pigments. For example pigments based on zinc sulphide (ZnS) or pigments based on strontium aluminate (SrAl₂O₄) can be used, the latter having essentially longer afterglow durations. Also the combination of different pigments is possible in order to combine different features. For example products can be produced which have both high initial brightness as well as a very long afterglow duration by mixing pigment types with corresponding features.

Further possibilities of coloring photoluminescent components are for example mixing of colored and fluorescent pigments as well as the application of color filters. Color filters for example can be printed onto the photoluminescent material or can be applied as foils. With them coloring is possible without loosing much of the brightness.

For the application in aircraft due to the mostly rather low illumination intensity, luminescent materials composed of pigments based on SrAl₂O₃ which are embedded in thermosetting resins are particularly suitable.

Corresponding photoluminescent components can be made which, for example, after a charging of 15 minutes luminesce for more than six hours or after a charging for 30 minutes luminesce for more than 11 hours.

Special pigments and their properties which are suitable and commercially available are:
Zinc sulphide: green luminescence, green color of the body, low price, short charging time until saturation, short afterglow time;
Strontium aluminate: green luminescence, high initial brightness, long afterglow duration, large excitation spectrum, good charging in case of low illumination; and
Calcium aluminate: blue luminescence, white body color, long afterglow duration, large excitation spectrum.

The use of light strips has also overcome the prejudice that the high light power of the light elements will be detrimental to the pilot's vision when flying at night. This problem does not arise with the already known light elements with incandescent lamps or LEDs. Since these are switched on only in the event of an accident, they cannot interfere with the pilot's vision when flying at night, even if they are illuminated very brightly, since they are switched off during normal flight. The already known photoluminescent strips in airplanes are also not subject to this problem, since the passenger cabin is illuminated in any case, and the light from the passenger cabins does not enter the cockpit.

A primary feature is that it has been identified that the light elements may on the one hand be sufficiently bright, but on the other hand do not adversely affect the pilot's vision when flying at night.

One advantageous embodiment provides that the aircraft has light elements of different colors at the edge of the windows. This makes it possible to provide instructions as to which windows are particularly suitable for use as emergency exits. A similar effect can be achieved by the aircraft having light elements of different brightness.

At least a number of windows are expediently completely surrounded by light elements. On the other hand, it is possible for a number of windows to be only partially surrounded by light elements. For example, it will be possible for the part of the border of a number of the windows not to be provided with light elements which would be detrimental to the pilot's vision by being reflected in the windshield.

1. A helicopter having light elements which are in the form of strips and are fitted to the edge of at least a number of windows, wherein the light elements are provided with photoluminescent material.

2. The helicopter as claimed in claim 1, wherein the helicopter has light elements of different colors.

3. The helicopter as claimed in claim 1, wherein the helicopter has light elements of different brightness.

4. The helicopter as claimed in claim 2, wherein the helicopter has light elements of different brightness.

5. The helicopter as claimed in one of claims 1, wherein a number of windows are completely surrounded by light elements.

6. The helicopter as claimed in one of claims 2, wherein a number of windows are completely surrounded by light elements.

7. The helicopter as claimed in one of claims 3, wherein a number of windows are completely surrounded by light elements.

8. The helicopter as claimed in one of claims 4, wherein a number of windows are completely surrounded by light elements.

9. The helicopter as claimed in one of claims 1, wherein a number of windows are only partially surrounded by light elements.

10. The helicopter as claimed in one of claims 2, wherein a number of windows are only partially surrounded by light elements.

11. The helicopter as claimed in one of claims 3, wherein a number of windows are only partially surrounded by light elements.

12. The helicopter as claimed in one of claims 4, wherein a number of windows are only partially surrounded by light elements.

13. The helicopter as claimed in one of claims 5, wherein a number of windows are only partially surrounded by light elements.

14. The helicopter as claimed in one of claims 6, wherein a number of windows are only partially surrounded by light elements.

15. The helicopter as claimed in one of claims 7, wherein a number of windows are only partially surrounded by light elements.

16. The helicopter as claimed in one of claims 8, wherein a number of windows are only partially surrounded by light elements.
